(19) United States
(12) Patent Application Publication
(10) Pub. No.: US 2015/0217570 A1
(43) Pub. Date: Aug. 6, 2015

(54) METHOD OF MANUFACTURING FLOW-PATH STRUCTURE, METHOD OF MANUFACTURING LIQUID EJECTING HEAD, AND METHOD OF MANUFACTURING LIQUID EJECTING APPARATUS

(71) Applicant: Seiko Epson Corporation, Shinjuku-ku (JP)

(72) Inventor: Hiroki MIYAJIMA, Matsumoto-shi (JP)

(21) Appl. No.: 14/610,189

(22) Filed: Jan. 30, 2015

(30) Foreign Application Priority Data
Feb. 3, 2014 (JP) 2014-018433

(51) Int. Cl. B41J 2/16

(52) U.S. Cl. CPC B41J 2/1623; B41J 2/1612

(57) ABSTRACT

A method of manufacturing a flow-path structure (liquid ejecting head) which includes a first member and a second member, and in which a flow path, through which a liquid is circulated, is formed, the method including: bonding the first member and the second member, in a state in which a pin of the first member is inserted through a through-hole of the second member, by an adhesive; and fixing the first member and the second member to each other by thermal tip-flattening through which the tip portion of the pin is deformed by being heated, before the adhesive is cured.

### BACKGROUND

1. Technical Field

The present invention relates to manufacture of a structure that includes a flow path through which a liquid is circulated.

2. Related Art

In the related art, a technology has been proposed, in which a flow path, through which a liquid is circulated, is configured to include a plurality of members which are assembled. For example, in JP-A-2010-184426, JP-A-2012-200963, and JP-A-2013-159051, a liquid ejecting head is disclosed, in which a liquid such as ink is circulated through a flow path that has a configuration in which a plurality of members are assembled and then is ejected from a plurality of nozzles.

According to technologies in JP-A-2010-184426, JP-A-2012-200963, and JP-A-2013-159051, the members that are assembled into the flow path are fixed to each other by using an adhesive. Accordingly, problems arise in that there is a need to secure time for curing the adhesive or in that there is a need to use a dedicated tool or space to hold the members until the adhesive is cured.

### SUMMARY

An advantage of some aspects of the invention is to reduce a cost of manufacturing a structure including a flow path.

According to an aspect of the invention, there is provided a method of manufacturing a flow-path structure which includes a first member and a second member, and in which a flow path, through which a liquid is circulated, is formed, the method including: bonding the first member and the second member by an adhesive; and fixing the first member and the second member by tip-flattening before the adhesive is cured. In this way, since the first member and the second member are fixed by the tip-flattening before the adhesive between both of the members is cured, there is no need to hold the first member and the second member until the adhesive is cured. Accordingly, time which is taken to manufacture the flow-path structure is shortened and there is no need to use a dedicated tool or space in order to hold the first member and the second member until the adhesive is cured. That is, it is possible to reduce a cost of manufacturing the flow-path structure.

According to another aspect of the invention, there is provided a method of manufacturing a liquid ejecting head which includes a first member and a second member, in which a flow path, through which a liquid is circulated, is formed, and which ejects, from a nozzle, the liquid that circulates in the flow path, the method including: bonding the first member and the second member by an adhesive; and fixing the first member and the second member by tip-flattening before the adhesive is cured. In this way, since the first member and the second member are fixed to each other by tip-flattening before the adhesive is cured, it is possible to reduce a cost of manufacturing the liquid ejecting head.

In the method of manufacturing a liquid ejecting head, in a case where a pin that is formed of a thermoplastic material is disposed on the first member, and a through-hole through which the pin is inserted is formed in the second member, it is preferred to employ a process of fixing the first member and the second member to each other by thermal tip-flattening through which the tip portion of the pin inserted through the through-hole is deformed by being heated. In this way, it is advantageous that the pin of the first member is less likely to be damaged.

According to still another aspect of the invention, there is provided a method of manufacturing a liquid ejecting apparatus which includes a first member and a second member, in which a flow path, through which a liquid is circulated, is formed, and which further includes a liquid ejecting head that ejects, from a nozzle, the liquid that circulates in the flow path, the method including: bonding the first member and the second member by an adhesive; and fixing the first member and the second member by tip-flattening before the adhesive is cured. In this way, since the first member and the second member are fixed to each other by tip-flattening before the adhesive between both of the members is cured, it is possible to reduce a cost of manufacturing the liquid ejecting apparatus. An example of the liquid ejecting apparatus is a printing apparatus that ejects ink onto a printing medium such as a printing sheet, but the application of the liquid ejecting apparatus according to the invention is not limited to printing.

### BRIEF DESCRIPTION OF THE DRAWINGS

The invention will be described with reference to the accompanying drawings, wherein like numbers reference like elements.

FIG. 1 is a diagram illustrating a configuration of a printing apparatus according to an embodiment of the invention.

FIG. 2 is a cross-sectional view of a liquid ejecting head.

FIG. 3 is a plan view of the liquid ejecting head when viewed from a printing medium side.

FIG. 4 is a diagram illustrating a process of manufacturing the liquid ejecting head.

### DESCRIPTION OF EXEMPLARY EMBODIMENTS

### Configuration of Printing Apparatus

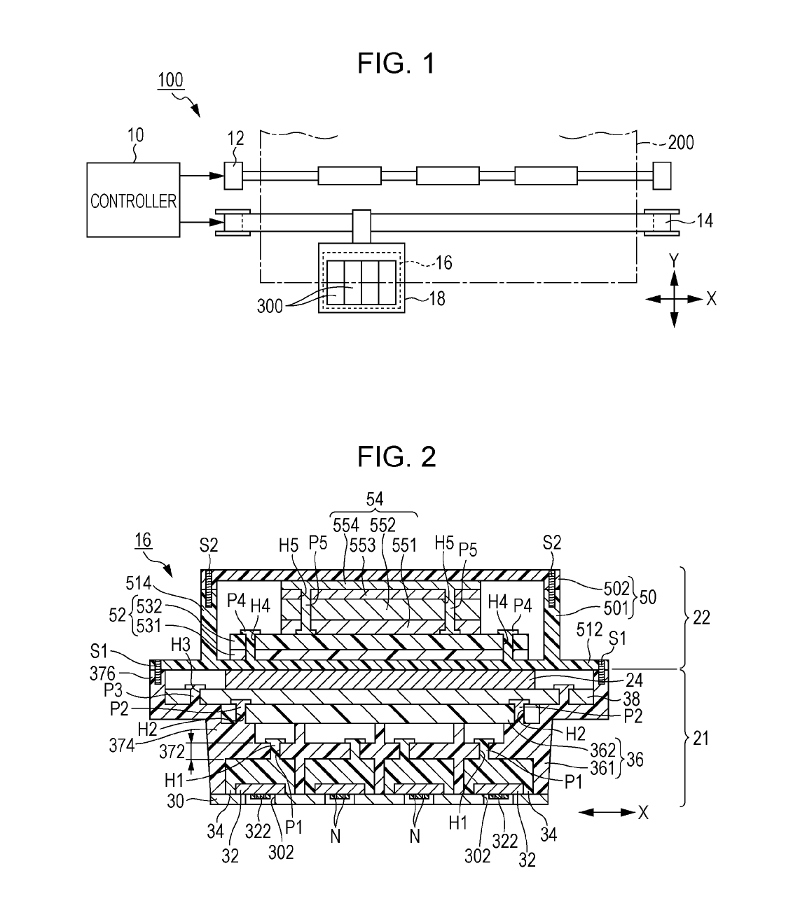

FIG. 1 is a diagram illustrating a partial configuration of an ink jet printing apparatus 100 according to an embodiment of the invention. The printing apparatus 100 is a liquid ejecting apparatus that ejects ink as an example of a liquid onto a printing medium 200 such as a printing sheet and forms an image on a front surface of the printing medium 200. The printing apparatus 100 includes a controller 10, a transport mechanism 12, a moving mechanism 14, a liquid ejecting head 16, and a carriage 18.

The controller 10 controls each component of the printing apparatus 100 collectively. The liquid ejecting head 16 is mounted on a carriage 18, along with a plurality of ink cartridges 300 which is filled with ink, and ejects the ink supplied from each ink cartridge 300 onto the printing medium 200 from a plurality of nozzles in accordance with control by the controller 10. The transport mechanism 12 transports the printing medium 200 in a Y direction (sub scanning direction) in accordance with control by the controller 10 and the moving mechanism 14 causes the carriage 18 to move back and forth in an X direction (main scanning direction) in accordance with control by the controller 10. While the printing medium 200 is transported and the carriage 18 moves back and forth, the liquid ejecting head 16 ejects the ink onto the printing medium 200 and thereby a desired image is formed on the printing medium 200.

FIG. 2 is a cross-sectional view (cross section perpendicular to the Y direction) of the liquid ejecting head 16. The liquid ejecting head 16 is configured to include a first structure 21, a second structure 22, and a communicating section 24. The first structure 21 is an element that ejects the ink from a plurality of nozzles N and the second structure 22 is an element that supplies the ink from each ink cartridge 300 to the first structure 21. The communicating section 24 causes a flow path inside the first structure 21 and a flow path inside the second structure 22 to communicate with each other. Specific shapes of the flow paths of the ink which are formed inside the first structure 21 and the second structure 22 are not illustrated in the drawings for convenience.

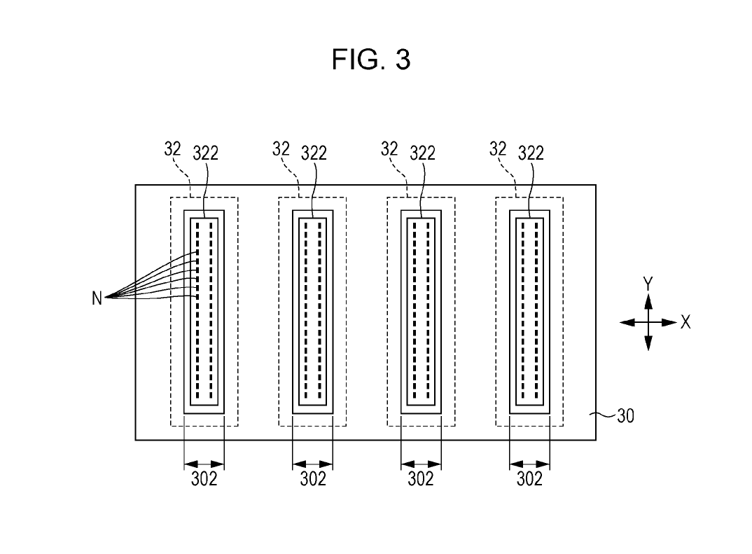

The first structure 21 includes a fixation plate 30, a plurality of head units 32, a plurality of support sections 34, a supply section 36, and a control substrate 38. FIG. 3 is a plan view of the first structure 21 when viewed from the printing medium 200 side (ink ejecting side). As illustrated in FIGS. 2 and 3, each of the plurality of head units 32 is a head chip that ejects the ink from the plurality of nozzles N. An arbitrary head unit 32 is configured to include a nozzle plate 322 in which two rows of the plurality of nozzles N are formed and a plurality of sets of pressure chambers and piezoelectric elements (not illustrated) corresponding to other nozzles N, respectively. The piezoelectric element vibrates by supplying of a drive signal, then pressure inside the pressure chamber is changed, and thereby the ink filling the pressure chamber is ejected from each nozzle N. Each head unit 32 has an arbitrary structure.

The fixation plate 30 is a flat plate material formed of a high-rigidity metal (for example, stainless steel), for example, and a plurality of openings 302 is formed corresponding to the head units 32, respectively. As illustrated in FIG. 3, each of the plurality of head units 32 is fixed on the front surface of the fixation plate 30 by using, for example, an adhesive, in a state in which the nozzle plate 322 is positioned on the inner side of the opening 302. As illustrated in FIG. 3, the plurality of head units 32 is arranged side by side along the X direction such that the plurality of nozzles N of each head unit 32 is arranged along the Y direction. Each of the plurality of support sections 34 is formed of, for example, a resin material, and supports the head unit 32. A storage chamber (reservoir), in which ink that is supplied to the head unit 32 is stored, and a flow path for supplying the ink to the storage chamber are formed inside the support section 34.

The supply section 36 is an element that supports the plurality of support sections 34 (the plurality of head units 32) and forms a flow path for supplying ink to the head unit 32. The supply section 36 is configured to include a flow path member 361 and a flow path member 362. The flow path member 361 is a structure that includes a bottom section 372, a side section 374, and a sticking-out section 376 and is formed of, for example, a resin material integrally by injection molding. The side section 374 is a wall-like section which protrudes from the circumferential edge of the bottom section 372 and the sticking-out section 376 is a section that protrudes from the side section 374 to the outer side.

Each of the plurality of support sections 34 is fixed between the fixation plate 30 and the bottom section 372 of the flow path member 361. Each of the support sections 34 and the fixation plate 30 are bonded to each other by using, for example, an adhesive. On the other hand, each of the support sections 34 and the flow path member 361 are fixed by bonding and tip-flattening. Specifically, as illustrated in FIG. 2, a pin P1 is formed on a front surface of each of the support sections 34 which is on the side opposite to the head unit 32 (surface facing the bottom section 372 of the flow path member 361) and a through-hole H1 through which the pin P1 is inserted is formed in the bottom section 372 of the flow path member 361. Each of the support sections 34 and the bottom section 372 of the flow path member 361 are fixed to each other by the tip-flattening in which the tip portion of the pin P1 inserted through the through-hole H1 is deformed, in addition to the bonding by the adhesive disposed between both of the sections.

The flow path member 362 is an element that forms, in cooperation with the flow path member 361, a flow path through which the ink is supplied to each of the head units 32 and is formed of, for example, a resin material and is fixed to the flow path member 361. The flow path member 361 and the flow path member 362 are fixed by the bonding and the tip-flattening. Specifically, as illustrated in FIG. 2, a pin P2 is formed on the side section 374 of the flow path member 361 and a through-hole H2 through which the pin P2 is inserted is formed in the flow path member 362. The flow path member 361 and the flow path member 362 are fixed to each other by the tip-flattening in which the tip portion of the pin P2 inserted through the through-hole H2 is deformed, in addition to the bonding by the adhesive disposed between both of the members.

The control substrate 38 in FIG. 2 is a circuit board on which a wire through which a drive signal or a power potential is supplied to each of the head unit 32 or a drive circuit that generates the drive signal is mounted. The drive signal or the power potential is supplied from the control substrate 38 to each of the head units 32 through the flexible circuit board (not illustrated) provided to connect each of the head units 32 and the control substrate 38.

The control substrate 38 is fixed to the sticking-out section 376 of the flow path member 361. The control substrate 38 and the flow path member 361 are fixed by the bonding and the tip-flattening. Specifically, as illustrated in FIG. 2, a pin P3 is formed on a front surface of the sticking-out section 376 of the flow path member 361 which is on the side opposite to the bottom section 372 and a through-hole H3 through which the pin P3 is inserted is formed in the control substrate 38. The control substrate 38 and the sticking-out section 376 of the flow path member 361 are fixed to each other by the tip-flattening in which the tip portion of the pin P3 inserted through the through-hole H3 is deformed, in addition to the bonding by the adhesive disposed between both of the elements. The flow path inside the communicating section 24 communicates with the flow path inside the supply section 36 through the through-hole (not illustrated) formed in the control substrate 38.

The second structure 22 in FIG. 2 includes a frame 50, a filter assembly 52, and a valve assembly 54. The frame 50 is a hollow case that is configured to include a first frame section 501 and a second frame section 502. The first frame section 501 and the second frame section 502 are fixed to each other by using a plurality of screws S2 and thereby the frame 50 is configured to accommodate and support the filter assembly 52 and the valve assembly 54 in the inside space of the frame 50. The first frame section 501 is a structure including a bottom section 512 and the side section 514 and is formed of, for example, a resin material integrally by injection molding. The side section 514 is a wall-like section which protrudes from the front surface of the bottom section 512 to the side opposite to the first structure 21. The flow path member 361 of the first structure 21 and the first frame section 501 of the second structure 22 are fixed to each other by using a plurality of screws S1. When the first structure 21 and the second structure 22 are fixed to each other, the communicating section 24 is interposed between both of the structures in a state of being pressed by both the flow path member 361 and the first frame section 501.

The filter assembly 52 is configured to include a flow path member 531 and a flow path member 532. A filter (not illustrated) through which ink that is supplied from the ink cartridge 300 to each of the head units 32 so as to remove air bubbles or foreign substances is held between the flow path member 531 and the flow path member 532. The flow path member 531 and the flow path member 532 are fixed to each other by using, for example, the adhesive.

The filter assembly 52 is fixed to the bottom section 512 of the first frame section 501. The filter assembly 52 and the first frame section 501 are fixed by the bonding and the tip-flattening. Specifically, as illustrated in FIG. 2, a pin P4 is formed on the front surface of the bottom section 512 of the first frame section 501 and a through-hole H4 through which the pin P4 is inserted is formed in the flow path member 531 and the flow path member 532. The filter assembly 52 and the first frame section 501 are fixed to each other by the tip-flattening in which the tip portion of the pin P4 inserted through the through-hole H4 is deformed, in addition to the bonding by the adhesive disposed between the flow path member 531 and the bottom section 512. The tip-flattening using the pin P4 of the bottom section 512 contributes to fixing of the flow path member 531 to the flow path member 532. That is, the flow path member 531 and the flow path member 532 are fixed to each other by the bonding using the adhesive between both of the members and the tip-flattening using the pin P4.

The valve assembly 54 is configured of stacking a plurality of flow path members 55 (551 to 554) and a regulating valve (for example, self-sealing valve or back-pressure control valve) that controls pressure of the ink supplied from the ink cartridge 300 is formed inside the valve assembly 54. The flow path members 55 are fixed by the bonding and the tip-flattening. Specifically, as illustrated in FIG. 2, a pin P5 is formed on the front surface of the flow path member 554 on the flow path members 551 to 553 side and a through-hole H5 through which the pin P5 is inserted is formed through the flow path members 551 to 553. The flow path members 55 of the valve assembly 54 are fixed to each other by the tip-flattening in which the tip portion of the pin P5 inserted through the through-hole H5 of the flow path members 551 to 553 is deformed, in addition to the bonding by the adhesive disposed between the members.

As described above, according to the present embodiment, by the bonding and the tip-flattening, the support section 34 and the flow path member 361 (bottom section 372) are fixed to each other, the flow path member 361 (side section 374) and the flow path member 362 are fixed to each other, the flow path member 361 (sticking-out section 376) and the control substrate 38 are fixed to each other, the first frame section 501 (bottom section 512) and the filter assembly 52 are fixed to each other, and the valve assembly 54 and the plurality of flow path members 55 are fixed to each other.

### Manufacturing Process

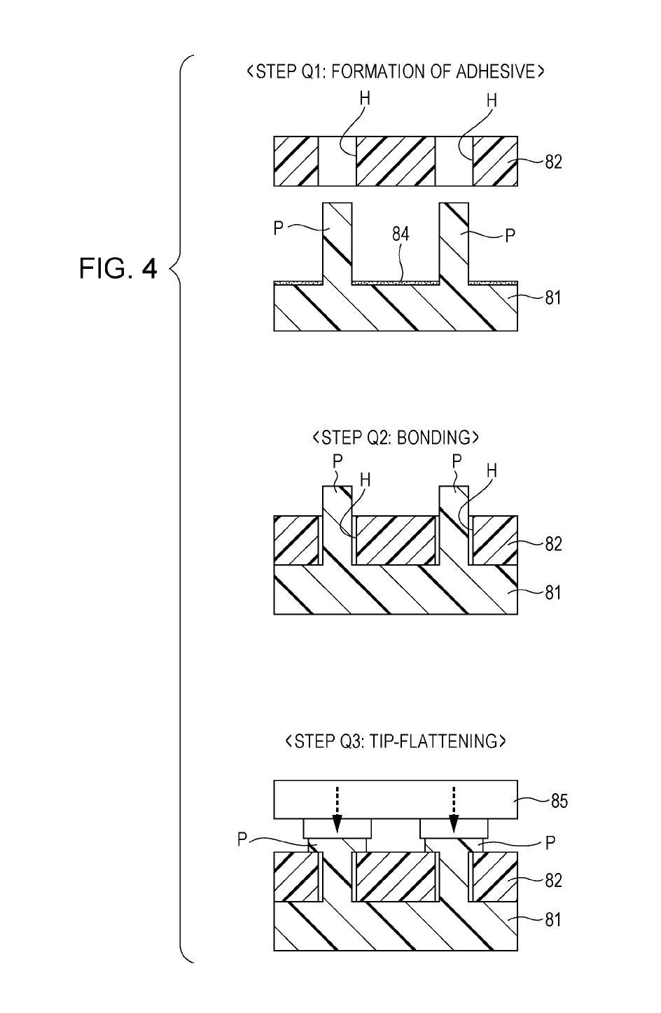

FIG. 4 is a diagram illustrating an assembly process, in which a plurality of members (first member 81 and second member 82) is fixed to each other by the bonding and the tip-flattening, of a process of manufacturing the liquid ejecting head 16. In FIG. 4, it is assumed that pins P (P1 to P5) are formed on the first member 81 and through-holes H (H1 to H5) are formed in the second member 82. The first member 81 that includes pins (tip-flattening pin) is integrally formed of a thermoplastic material (for example, resin material) that is deformed by being heated. In the configuration of FIG. 2, the support section 34, the side section 374 of the flow path member 361, the sticking-out section 376 of the flow path member 361, the bottom section 512 of the first frame section 501, and the flow path member 554 correspond to the first member 81. The bottom section 372 of the flow path member 361, the flow path member 362, the control substrate 38, the filter assembly 52, and the flow path members 551 to 553 of the valve assembly 54 correspond to the second member 82.

As illustrated in FIG. 4, first, an adhesive 84 is formed on at least one of front surfaces of the first member 81 and the second member 82 (step Q1). For example, the fluidal adhesive 84 is applied on the front surface of the first member 81 or the second member 82. FIG. 4 illustrates a state in which the adhesive 84 is formed on the front surface of the first member 81; however, it is possible to form the adhesive 84 on the front surface of the second member 82 or both of the front surfaces of the first member 81 and the second member 82. In addition, it is possible to dispose a film body (double-sided tape), which has the adhesive 84 applied on both surfaces thereof, on one front surface of the first member 81 or the second member 82. When the formation of the adhesive 84 is completed, the first member 81 and the second member 82 are bonded by the adhesive 84, as illustrated in FIG. 4, in a state in which the pins P of the first member 81 are inserted through the through-holes H of the second member 82 (step Q2).

Before the adhesive 84 formed in step Q1 is cured, step Q3 in FIG. 4 is performed. In step Q3, the tip portions of the pins P which protrude from the front surface of the second member 82 which is on the side opposite to the first member 81 is deformed by being heated or pressed by a heating device (heater) 85 (step Q3). The first member 81 and the second member 82 are fixed to each other by tip-flattening in step Q3 (thermal tip-flattening). The adhesive 84 is cured after step Q3 is performed. That is, the tip-flattening (step Q3) of the first member 81 and the second member 82 is accepted as means for holding (temporary fixing) of the first member 81 and the second member 82 until the adhesive 84 is cured completely. Through a manufacturing process which includes steps Q1 to Q3 illustrated in FIG. 4, the liquid ejecting head 16 (further, printing apparatus 100) is manufactured.

As described above, according to the present embodiment, the first member 81 and the second member 82 which configure the liquid ejecting head 16 are fixed by the tip-flattening before the adhesive 84 between both of the members are cured. Accordingly, there is no need to hold the first member 81 and the second member 82 to remain in a state obtained after step Q2 is performed until the adhesive 84 is cured. That is, time which is taken to manufacture the liquid ejecting head 16 is shortened. In addition, there is no need to use a dedicated tool or space in order to hold the first member 81 and the second member 82 until the adhesive 84 is cured. As described above, according to the present embodiment, it is possible to reduce a cost of manufacturing a structure that forms a flow path by joining the first member 81 with the second member 82. According to the present embodiment, particularly, since the thermal tip-flattening, in which the pin P made of the thermoplastic material is deformed by being heated, is employed, it is advantageous that a possibility of damaging the pin P or the like is suppressed compared to a case where the pin P is not heated.

### Modification Example

The above-described embodiments can be modified variously. Specific aspects of modification examples are as follows. Two or more aspects selected randomly from the following examples can be combined appropriately within a range in which the selected aspects do not contradict each other.

(1) According to the above-described embodiments, the pins P (P1 to P5) are formed on the support section 34, side section 374 of the flow path member 361, the sticking-out section 376 of the flow path member 361, the bottom section 512 of the first frame section 501, and the flow path member 554 and the through-holes H (H1 to H5) are formed in the bottom section 372 of the flow path member 361, the flow path member 362, the control substrate 38, the filter assembly 52, and the flow path members 551 to 553 of the valve assembly 54; however it is possible to reverse the relationship between the pins P and the through-holes H. For example, through-holes H (H1 to H5) are formed on the support section 34, side section 374 of the flow path member 361, the sticking-out section 376 of the flow path member 361, the bottom section 512 of the first frame section 501, and the flow path member 554 (second members 82) and the pins P (P1 to P5) are formed in the bottom section 372 of the flow path member 361, the flow path member 362, the control substrate 38, the filter assembly 52, and the flow path members 551 to 553 of the valve assembly 54 (first members 81), and thus a configuration in which the pins P are inserted through the through-holes H, respectively, is also employed.

(2) According to the above-described embodiments, the liquid ejecting head 16 that ejects the ink from the plurality of nozzles N is described; however, the invention can be applied to various structures in addition to the liquid ejecting head 16. For example, it is possible to apply the invention to a structure in which a flow path to supply ink to the liquid ejecting head 16 is formed. In addition, it is possible to apply the invention even to a single part (element that does not include a function of liquid ejection) of the filter assembly 52 or the valve assembly 54 as an example according to the above-described embodiments. As understood by the above examples, an application target of the invention is comprehensively expressed as the flow-path structure in which a flow path, through which a liquid circulates, is formed and the liquid ejecting head 16 as an example according to the above-described embodiments is an example of the flow-path structure.

In addition, the examples of the first member 81 and the second member 82 which are included in the flow path structure include members that form the flow path themselves (that is, elements that configure the inner circumferential surface of the flow path); however, elements such as the control substrate 38 or the frame 50 (first frame section 501) in the above-described embodiments which do not contribute directly to forming of the flow path can correspond to the first member 81 and the second member 82.

(3) A method of ejecting ink by the liquid ejecting head 16 is not limited to the above-described method in which the piezoelectric element is used (piezoelectric method). For example, the invention can be applied even to a type of liquid ejecting head 16 in which a heating element that generates air bubbles in the pressure chamber by heating and changes the pressure in the pressure chamber is used (thermal method). In addition, according to the above-described embodiments, the serial type printing apparatus 100 is exemplified, in which the liquid ejecting head 16 is mounted on the carriage 18 and is caused to move back and forth; however, the invention is applied even to the line type printing apparatus 100 in which a plurality of liquid ejecting heads 16 is arranged in a sub direction (Y direction) of the printing medium 200.

(4) The printing apparatus 100 exemplified in the embodiments can be employed in various apparatuses such as a facsimile or a copy machine, in addition to an apparatus dedicated to printing. Above all, the use of the liquid ejecting apparatus of the invention is not limited to printing. For example, a liquid ejecting apparatus that ejects a color solution is utilized as a manufacturing apparatus that forms a color filter of a liquid crystal display apparatus. In addition, a liquid ejecting apparatus that ejects a conductive material solution is utilized as a manufacturing apparatus that forms a wiring or an electrode of the circuit board.

What is claimed is:

1. A method of manufacturing a flow-path structure which includes a first member and a second member, and in which a flow path, through which a liquid is circulated, is formed, the method comprising:
bonding the first member and the second member by an adhesive; and
fixing the first member and the second member by tip-flattening before the adhesive is cured.

2. A method of manufacturing a liquid ejecting head which includes a first member and a second member, in which a flow path, through which a liquid is circulated, is formed, and which ejects, from a nozzle, the liquid that circulates in the flow path, the method comprising:
bonding the first member and the second member by an adhesive; and
fixing the first member and the second member by tip-flattening before the adhesive is cured.

3. The method of manufacturing a liquid ejecting head according to claim 2,
wherein a pin that is formed of a thermoplastic material is disposed on the first member,
wherein a through-hole through which the pin is inserted is formed in the second member, and
wherein the first member and the second member are fixed to each other by thermal tip-flattening through which the tip portion of the pin inserted through the through-hole is deformed by being heated.

4. A method of manufacturing a liquid ejecting apparatus which includes a first member and a second member, in which a flow path, through which a liquid is circulated, is formed, and which includes a liquid ejecting head that ejects, from a nozzle, the liquid that circulates in the flow path, the method comprising:
bonding the first member and the second member by an adhesive; and
fixing the first member and the second member by tip-flattening before the adhesive is cured.
